(19) United States
(12) Patent Application Publication
(10) Pub. No.: US 2022/0157178 A1
(43) Pub. Date: May 19, 2022

(54) DISASTER AND EMERGENCY SURVEILLANCE USING A DISTRIBUTED FLEET OF AUTONOMOUS ROBOTS

(71) Applicant: GM Cruise Holdings LLC, San Francisco, CA (US)

(72) Inventors: Nestor Grace, San Francisco, CA (US); Diego Plascencia-Vega, San Francisco, CA (US); Dogan Gidon, Berkeley, CA (US); Clifton Trigg Hutchinson, Jr., Dallas, TX (US)

(21) Appl. No.: 17/098,519

(22) Filed: Nov. 16, 2020

(51) Int. Cl. G08G 5/00; G01C 21/00; G05D 1/00; G05D 1/10; B64C 39/02; G06Q 10/06

(52) U.S. Cl. CPC G08G 5/0043; G01C 21/3841; G01C 21/3807; G05D 1/0088; G05D 1/104; B64C 2201/143; B64C 39/024; G06Q 10/0631; B64C 2201/027; B64C 2201/12; G08G 5/003

(57) ABSTRACT

The disclosed technology provides solutions for performing disaster and emergency surveillance and in particular, for maintaining a Common Operating Picture (COP) using a fleet of distributed robots. A COP maintenance process can include steps for receiving a disaster notification identifying an affected area, and deploying autonomous robots to a map location corresponding with the disaster location. In some aspects, the process can further include steps for receiving updated map information from the one or more autonomous robots. Systems and machine-readable media are also provided.

### BACKGROUND

### 1. Technical Field

The subject technology relates to solutions for performing disaster and emergency surveillance and in particular, for maintaining a Common Operating Picture (COP) using a fleet of distributed robots.

### 2. Introduction

Autonomous vehicles (AVs) are vehicles having computers and control systems that perform driving and navigation tasks that are conventionally performed by a human driver. As AV technologies continue to advance, ride-sharing services will increasingly utilize AVs to improve service efficiency and safety. However, AVs will be required to perform many of the functions that are conventionally performed by human drivers, such as avoiding dangerous or difficult routes, and performing other navigation and routing tasks necessary to provide a safe and efficient transportation. Such tasks may require the collection and processing of large quantities of data using various sensor types, including but not limited to cameras and/or Light Detection and Ranging (LiDAR) sensors disposed on the AV.

### BRIEF DESCRIPTION OF THE DRAWINGS

Certain features of the subject technology are set forth in the appended claims. However, the accompanying drawings, which are included to provide further understanding, illustrate disclosed aspects and together with the description serve to explain the principles of the subject technology. In the drawings:

FIG. 1 illustrates an example environment in which a fleet management system of the disclosed technology may be implemented.

FIG. 2 illustrates an example map area in which a disaster and emergency surveillance process may be implemented, according to some aspects of the disclosed technology.

FIG. 3 illustrates a flow diagram of various functions that can be used to implement a fleet management system that is configured to perform disaster and emergency surveillance, according to some aspects of the disclosed technology.

FIG. 4 illustrates steps of an example process for using a fleet management system to implement disaster and emergency surveillance operations, according to some aspects of the disclosed technology.

FIG. 5 illustrates an example system environment that can be used to facilitate AV dispatch and operations, according to some aspects of the disclosed technology.

FIG. 6 illustrates an example processor-based system with which some aspects of the subject technology can be implemented.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a more thorough understanding of the subject technology. However, it will be clear and apparent that the subject technology is not limited to the specific details set forth herein and may be practiced without these details. In some instances, structures and components are shown in block diagram form in order to avoid obscuring the concepts of the subject technology.

As described herein, one aspect of the present technology is the gathering and use of data available from various sources to improve quality and experience. The present disclosure contemplates that in some instances, this gathered data may include personal information. The present disclosure contemplates that the entities involved with such personal information respect and value privacy policies and practices.

Some AV fleet deployment systems maintain databases of routes that are not drivable, or should be avoided, e.g., due to obstructions, such as construction or poor roadway conditions. Map areas to be avoided can be indicated using a zonal blacklist (or avoidance area) indicator that can be referenced by every fleet vehicle. Although, zonal blacklists (avoidance areas) may indicate roadways/routes to be avoided, conventional zonal blacklists do not take into consideration emergency situations, such as natural disasters that may occur away from mapped roadways, but that can affect traffic flows. Additionally, conventional zonal blacklists do not provide information about various other types of emergencies, such as natural disasters.

Aspects of the disclosed technology address the foregoing limitations of conventional zonal blacklisting systems by providing a fleet management system that is configured to strategically deploy autonomous robots to collect data regarding dynamic emergency situations. In some aspects, the management system can also perform functions to integrate collected environmental data into a Common Operating Picture (COP) or centralized model of evolving disaster situations. In some aspects, the COP can provide a static visualization of a given map area (e.g., a city), with dynamic representations of damage, impacted populations, resources available to first responders and disaster management personnel, and any other relevant information potentially critical for decision makers. As discussed in further detail below, the COP can include maps that indicate the status of roadways, for example, to enable disaster management personnel to effectively plan routes.

By way of example, the COP may include one or more databases that are periodically (or continuously) updated to reflect map changes based on changes to real world disaster/emergency conditions, as well as changes to other salient resources or objects of interest Such changes can be based on information regarding the location, type, and severity of damage, population statistics, and/or resource allocations, etc. By deploying and effectively managing a fleet of autonomous robots, the disclosed fleet management system can maintain a COP that can facilitate disaster mitigation efforts, rescue operations, and that can inform resource deployment. As discussed in further detail below, the COP can be augmented with data provided by third-party entities, and can also be used by such entities (e.g., emergency responders) to facilitate disaster recovery efforts.

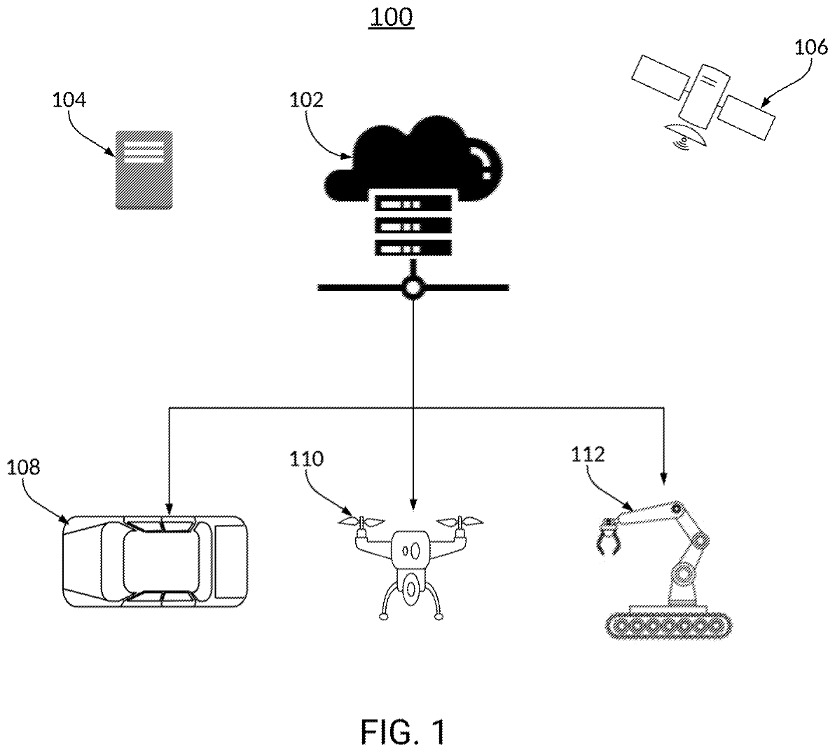

FIG. 1 illustrates an example network environment 100 in which a fleet management system 102 can be implemented. Management system 102 is connected to multiple network entities and autonomous robots, e.g., via a computer network, such as the Internet. In environment 100, management system 102 is communicatively coupled to various third-party devices, e.g., server 104, and satellite network 106. Third-party devices (104, 106) can include one or more emergency responder services, weather services (e.g., satellite weather monitoring systems), and/or other various entities that are capable of collecting emergency and/or disaster data for a particular location.

Additionally, fleet management system 102 is configured to communicate with various autonomous robotic devices, e.g., autonomous vehicle (AV) 108, drone 110, and robotic system 112. Although three types of robotic devices (108, 110, and 112) are depicted, it is understood, that different and/or additional types of robotic devices may be implemented, without departing from the scope of the invention. As discussed in further detail below, robotic devices (108, 110, 112), can include various sensors (e.g., environmental sensors) that are configured to sense and/or measure characteristics of a surrounding environs, and provide collected environmental data to management system 102. Robotic devices (108, 110, 112) can include various types of sensors, including, but not limited to one or more: cameras, Light Detection and Ranging (LiDAR) sensors, sonar sensors, thermometers, ultrasonic sensors, and/or infra-red (IR) sensors, and the like. Such sensors can be used for collecting data regarding various emergency/disaster situations, and/or for performing localization and mapping functions, e.g., simultaneous localization and mapping (SLAM) operations for unknown or altered landscapes.

In practice, fleet management system 102 is configured to deploy autonomous robotic devices (108, 110, 112) to collect environmental data with respect to various emergency situations and/or natural disasters. For example, management system 102 can be configured to coordinate the deployment of robotic devices (108, 110, 112) to collect environmental data with respect to natural disasters, including but not limited to: fires, landslides, hurricanes, floods, tornados, earthquakes, and/or man-made disasters, e.g., building collapses, explosions, chemical/radiation leaks, etc. It is understood that robotic devices (108, 110, 112) may also be deployed to collect environmental data with respect to other disaster or emergency situations, such as man-made emergencies, e.g., vehicle accidents.

In some aspects, deployment of robotic devices (108, 110, 112) may be based on a disaster type and/or a disaster location. For disaster situations not located near usable roadways, flying robots (e.g., drone 110) and/or robots with off-road terrain capabilities (e.g., robotic system 112) may be preferred. After robotic devices (108, 110, 112) have been deployed to a map location corresponding with a location of the emergency/disaster, robotic devices (108, 110, 112) can collect environmental data in relation to that location (e.g., map information), and provide the updated map information back to the fleet management system 102.

Updated map information can be used to build dynamic models of evolving disaster or emergency situations, such as to form a common operating picture (COP) that can be used to inform the deployment of resources, including disaster relief efforts and rescue efforts. In some aspects, updated map data for an emergency/disaster situation can be provided by one or more third-party systems, such as by an emergency responder network (e.g., server 104), and/or a weather service, e.g. satellite weather service 106. The COP may be used by emergency responders (e.g., fire departments, emergency medical services, police, etc.), for example, to help inform what resources should be deployed and to what locations. In some aspects the COP may be used to better understand how a disaster situation is evolving. By way of example, regular map information updates to the COP may inform firefighters about changing fire conditions, for example, by providing updated readings of temperature and/or particulate matter, etc. Such data can also be used to help to identify at-risk populations and/or property based on dynamic situational data collected by robotic devices (108, 110, 112). By way of further example, the COP may also include blacklisted vehicle routes that identify unsafe roadways that should be avoided by emergency responders and civilians.

By providing better situational awareness of dynamic emergency situations, the COP administered by fleet management system 102 can reduce disaster response times and improve the efficiency of emergency responder resource deployment.

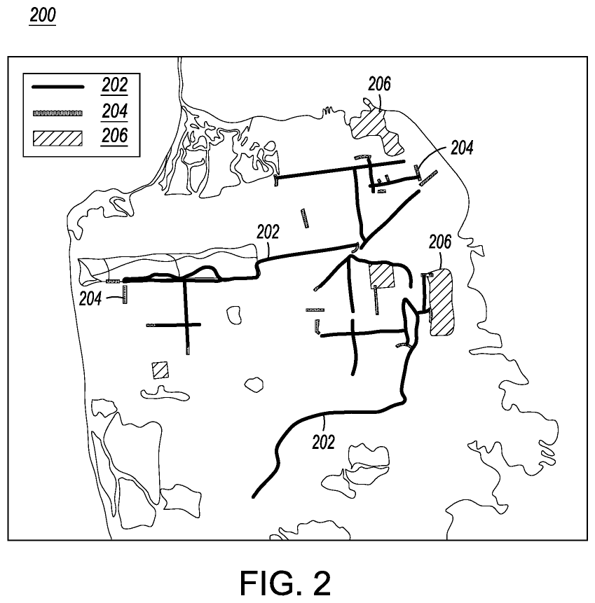

FIG. 2 illustrates an example map area 200 in which a disaster and emergency surveillance process may be implemented. In the example of map area 200, roadway usability is indicated by routable map areas 202, and blocked areas 204. Free zones 206 can indicate roadways or map areas that are unaffected by disaster/emergency situations. In some approaches, map 200 may be provided as part of a Common Operating Picture (COP) that is updated and served by a fleet management system, such as management system 102, discussed above.

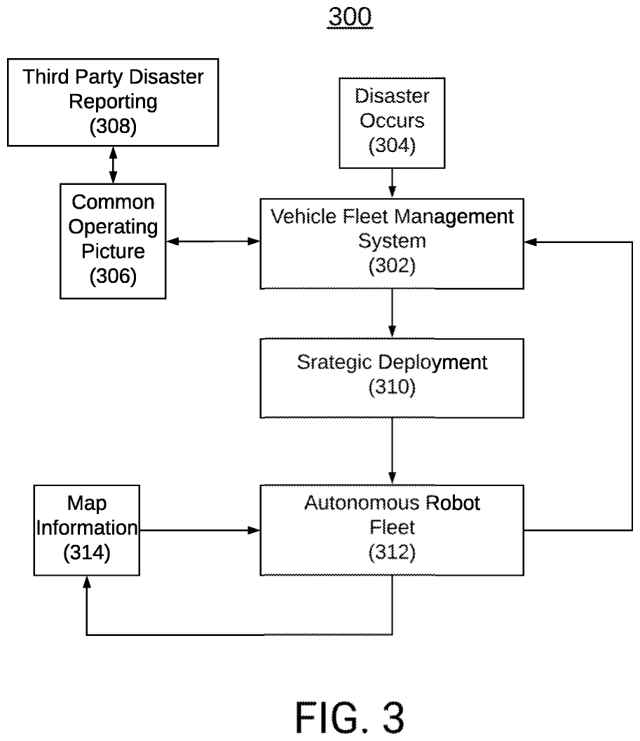

FIG. 3 illustrates a flow diagram 300 of various functions that can be used to implement a fleet management system configured to perform disaster and emergency surveillance, according to some aspects of the disclosed technology. As illustrated, vehicle fleet management system 302 can receive an indication of one or more disaster/emergency events (304). Disaster events 304 can be received at management system 302 from data received by one or more autonomous robots (e.g., autonomous robots 108, 110, 112, discussed above). Additionally, disaster events 304 may be received by one or more third-party systems, such as from a public or private emergency responder (e.g., a fire department, police station, weather service, news service, or medical service, etc.). Based on the location and type of disaster, fleet management system can selectively deploy one or more autonomous robots to perform data collection. As discussed above, autonomous robots can be deployed to a map location corresponding to a location of the emergency/disaster indicated by disaster event 304 (310). In some instances, the autonomous robot may be deployed to a location adjacent to an event (such as a fire. In some instances, aerial robots (e.g., drones) may be deployed to fly above or around a disaster area, e.g., a flooded area, a fire, or a collapsed building or roadway, etc.

Once properly positioned, autonomous robot fleet (312) can collect environmental data from one or more sensors. By way of example, robot fleet (312) may collect data regarding an atmospheric particulate density (e.g., using LiDAR sensors), or heat information (using IR sensors) for a burning fire. The autonomous robots may also identify or verify locations of people, property, and/or other resources that can help first responders understand a disaster situation and manage emergency relief efforts.

In some aspect, autonomous robots (312) can perform performing localization and mapping functions, e.g., simultaneous localization and mapping (SLAM) operations for unknown or altered landscapes. Localization functions, in conjunction with collected environmental data, can be used to update map information (314) that is then provided by fleet robots (312) back to management system (302). As discussed above, the updated map information can be used by fleet management system 302 top update manage/update a Common Operating Picture (COP) 306. In turn, COP 306 can be provided to one or more third-party systems or agencies, such as third-party disaster reporting system 308. Furthermore, COP 306 may be directly updated using information received from one or more third-party disaster reporting agencies or organizations. As such, COP 306 can represent a collaborative updatable/dynamic model of a disaster situation.

It is understood that one or more of autonomous/fleet robots 312 may be configured for semi-autonomous operation. For example, various robot performed functions may be aided by a remote-operator. By way of example, human-assisted remote operation can be used to facilitate robot navigation and/or surveillance operations in challenging situations.

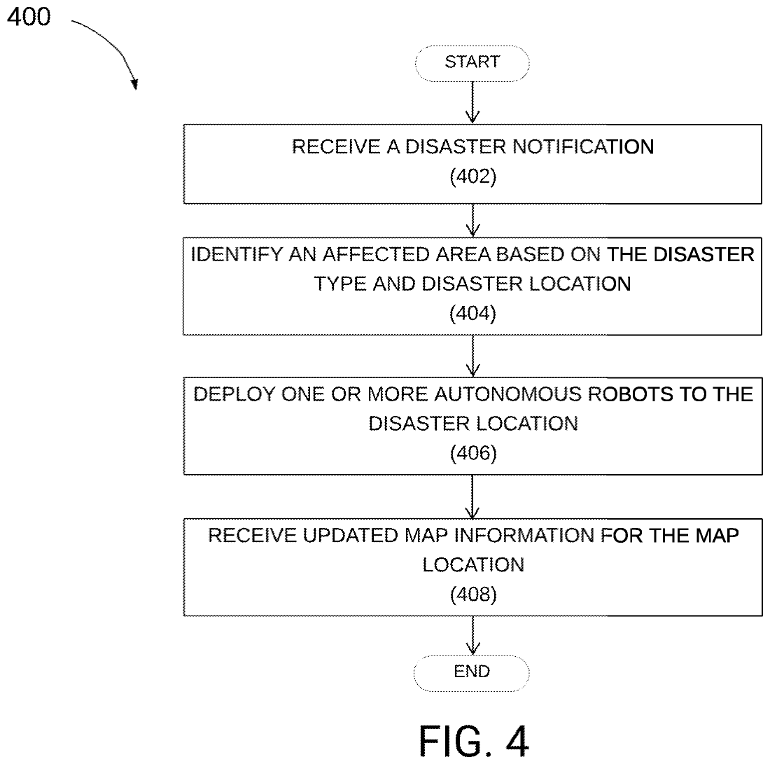

FIG. 4 illustrates steps of an example process 400 for using a fleet management system to implement disaster and emergency surveillance operations. Process 400 begins with step 402 in which a disaster notification (or event) is received by the management system. As discussed above, the disaster notification may be received from a third-party, such as an emergency responder, weather service, or news service, etc. However, in some instances, the emergency can be detected using data collected from one or more autonomous robots. By way of example, traffic accidents, or other disasters (e.g., fires, floods, earthquakes, sink holes, etc.) may be identified from environmental data collected by an autonomous vehicle (AV), or another autonomous robot.

Once the disaster notification has been received, an affected area associated with the disaster can be determined (step 404). For instance, map areas associated with the disaster may be expansive enough to fully contain or surround the known boundaries of the disaster event. In some aspects, e.g., for floods or fires, a greater perimeter around the disaster area may be identified to ensure that the danger zone is adequately contained in the map representation. By way of example, map areas can be determined using a predefined threshold distance specifying a radial distance from a disaster area (e.g., the edge of a flooded area or affected fire site). In some implementations, the map area containing the disaster event may be based on the disaster event type; for example, larger map areas may be used to define a disaster location associated with a dynamic emergency event (such as a fire), whereas smaller map areas may define a disaster location associated with a non-dynamic event, such as a building collapse or sink-hole, etc. In some implementations, map areas may be combined to encompass the loci of two or more emergency events, in this way, map areas can be used to define safety boundaries that provide safe distance estimates from a disaster event.

In step 406, one or more autonomous robots are deployed to the disaster location. In some aspects, the deployment (or re-deployment) of one or more autonomous robots can be based on a data collection cadence determined by the management system. The data collection cadence can determine how frequently data is collected, and can thereby be used to control the time-interval between updates on the situation. The data collection cadence may be determined by a number of different factors, including but not limited to: a number of autonomous robots available to perform data collection, disaster/emergency type, the size of area affected by the disaster, and/or recent changes to the disaster or developments in the disaster response plan, etc.

In step 408, updated map information is received from one or more of the autonomous robots. In some aspects, updated map information may be received wirelessly (e.g., via a wireless backhaul network, or a cellular network). In other aspects, data may be retrieved from a storage device that is resident on an autonomous robot. As discussed above, updated map information can be integrated into a Common Operating Picture (COP), that can be used to provide insights regarding the changing nature of the disaster situation.

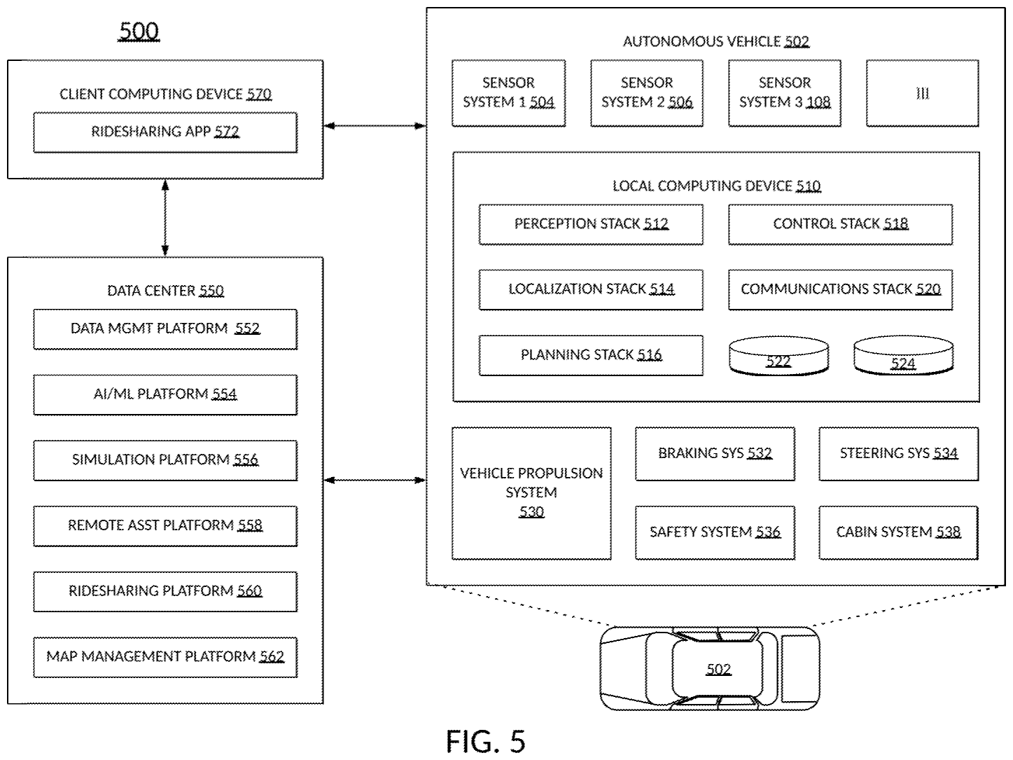

Turning now to FIG. 5 illustrates an example of an AV management system 500. One of ordinary skill in the art will understand that, for the AV management system 500 and any system discussed in the present disclosure, there can be additional or fewer components in similar or alternative configurations. The illustrations and examples provided in the present disclosure are for conciseness and clarity. Other embodiments may include different numbers and/or types of elements, but one of ordinary skill the art will appreciate that such variations do not depart from the scope of the present disclosure.

In this example, the AV management system 500 includes an AV 502, a data center 550, and a client computing device 570. The AV 502, the data center 550, and the client computing device 570 can communicate with one another over one or more networks (not shown), such as a public network (e.g., the Internet, an Infrastructure as a Service (IaaS) network, a Platform as a Service (PaaS) network, a Software as a Service (SaaS) network, other Cloud Service Provider (CSP) network, etc.), a private network (e.g., a Local Area Network (LAN), a private cloud, a Virtual Private Network (VPN), etc.), and/or a hybrid network (e.g., a multi-cloud or hybrid cloud network, etc.).

AV 502 can navigate about roadways without a human driver based on sensor signals generated by multiple sensor systems 504, 506, and 508. The sensor systems 504-508 can include different types of sensors and can be arranged about the AV 502. For instance, the sensor systems 504-508 can comprise Inertial Measurement Units (IMUs), cameras (e.g., still image cameras, video cameras, etc.), light sensors (e.g., LIDAR systems, ambient light sensors, infrared sensors, etc.), RADAR systems, GPS receivers, audio sensors (e.g., microphones, Sound Navigation and Ranging (SONAR) systems, ultrasonic sensors, etc.), engine sensors, speedometers, tachometers, odometers, altimeters, tilt sensors, impact sensors, airbag sensors, seat occupancy sensors, open/closed door sensors, tire pressure sensors, rain sensors, and so forth. For example, the sensor system 504 can be a camera system, the sensor system 506 can be a LIDAR system, and the sensor system 508 can be a RADAR system. Other embodiments may include any other number and type of sensors.

AV 502 can also include several mechanical systems that can be used to maneuver or operate AV 502. For instance, the mechanical systems can include vehicle propulsion system 530, braking system 532, steering system 534, safety system 536, and cabin system 538, among other systems. Vehicle propulsion system 530 can include an electric motor, an internal combustion engine, or both. The braking system 532 can include an engine brake, brake pads, actuators, and/or any other suitable componentry configured to assist in decelerating AV 502. The steering system 534 can include suitable componentry configured to control the direction of movement of the AV 502 during navigation. Safety system 536 can include lights and signal indicators, a parking brake, airbags, and so forth. The cabin system 538 can include cabin temperature control systems, in-cabin entertainment systems, and so forth. In some embodiments, the AV 502 may not include human driver actuators (e.g., steering wheel, handbrake, foot brake pedal, foot accelerator pedal, turn signal lever, window wipers, etc.) for controlling the AV 502. Instead, the cabin system 538 can include one or more client interfaces (e.g., Graphical User Interfaces (GUIs), Voice User Interfaces (VUIs), etc.) for controlling certain aspects of the mechanical systems 530-538.

AV 502 can additionally include a local computing device 510 that is in communication with the sensor systems 504-508, the mechanical systems 530-538, the data center 550, and the client computing device 570, among other systems. The local computing device 510 can include one or more processors and memory, including instructions that can be executed by the one or more processors. The instructions can make up one or more software stacks or components responsible for controlling the AV 502; communicating with the data center 550, the client computing device 570, and other systems; receiving inputs from riders, passengers, and other entities within the AV's environment; logging metrics collected by the sensor systems 504-508; and so forth. In this example, the local computing device 510 includes a perception stack 512, a mapping and localization stack 514, a planning stack 516, a control stack 518, a communications stack 520, an HD geospatial database 522, and an AV operational database 524, among other stacks and systems.

Perception stack 512 can enable the AV 502 to “see” (e.g., via cameras, LIDAR sensors, infrared sensors, etc.), “hear” (e.g., via microphones, ultrasonic sensors, RADAR, etc.), and “feel” (e.g., pressure sensors, force sensors, impact sensors, etc.) its environment using information from the sensor systems 504-508, the mapping and localization stack 514, the HD geospatial database 522, other components of the AV, and other data sources (e.g., the data center 550, the client computing device 570, third-party data sources, etc.). The perception stack 512 can detect and classify objects and determine their current and predicted locations, speeds, directions, and the like. In addition, the perception stack 512 can determine the free space around the AV 502 (e.g., to maintain a safe distance from other objects, change lanes, park the AV, etc.). The perception stack 512 can also identify environmental uncertainties, such as where to look for moving objects, flag areas that may be obscured or blocked from view, and so forth.

Mapping and localization stack 514 can determine the AV's position and orientation (pose) using different methods from multiple systems (e.g., GPS, IMUs, cameras, LIDAR, RADAR, ultrasonic sensors, the HD geospatial database 522, etc.). For example, in some embodiments, the AV 502 can compare sensor data captured in real-time by the sensor systems 504-508 to data in the HD geospatial database 522 to determine its precise (e.g., accurate to the order of a few centimeters or less) position and orientation. The AV 502 can focus its search based on sensor data from one or more first sensor systems (e.g., GPS) by matching sensor data from one or more second sensor systems (e.g., LIDAR). If the mapping and localization information from one system is unavailable, the AV 502 can use mapping and localization information from a redundant system and/or from remote data sources.

The planning stack 516 can determine how to maneuver or operate the AV 502 safely and efficiently in its environment. For example, the planning stack 516 can receive the location, speed, and direction of the AV 502, geospatial data, data regarding objects sharing the road with the AV 502 (e.g., pedestrians, bicycles, vehicles, ambulances, buses, cable cars, trains, traffic lights, lanes, road markings, etc.) or certain events occurring during a trip (e.g., emergency vehicle blaring a siren, intersections, occluded areas, street closures for construction or street repairs, double-parked cars, etc.), traffic rules and other safety standards or practices for the road, user input, and other relevant data for directing the AV 502 from one point to another. The planning stack 516 can determine multiple sets of one or more mechanical operations that the AV 502 can perform (e.g., go straight at a specified rate of acceleration, including maintaining the same speed or decelerating; turn on the left blinker, decelerate if the AV is above a threshold range for turning, and turn left; turn on the right blinker, accelerate if the AV is stopped or below the threshold range for turning, and turn right; decelerate until completely stopped and reverse; etc.), and select the best one to meet changing road conditions and events. If something unexpected happens, the planning stack 516 can select from multiple backup plans to carry out. For example, while preparing to change lanes to turn right at an intersection, another vehicle may aggressively cut into the destination lane, making the lane change unsafe. The planning stack 516 could have already determined an alternative plan for such an event, and upon its occurrence, help to direct the AV 502 to go around the block instead of blocking a current lane while waiting for an opening to change lanes.

Control stack 518 can manage the operation of the vehicle propulsion system 530, braking system 532, steering system 534, safety system 536, and cabin system 538. Control stack 518 can receive sensor signals from the sensor systems 504-508 as well as communicate with other stacks or components of the local computing device 510 or a remote system (e.g., the data center 550) to effectuate operation of the AV 502. For example, the control stack 518 can implement the final path or actions from the multiple paths or actions provided by the planning stack 516. This can involve turning the routes and decisions from the planning stack 516 into commands for the actuators that control the AV's steering, throttle, brake, and drive unit.

The communication stack 520 can transmit and receive signals between the various stacks and other components of the AV 502 and between the AV 502, the data center 550, the client computing device 570, and other remote systems. The communication stack 520 can enable the local computing device 510 to exchange information remotely over a network, such as through an antenna array or interface that can provide a metropolitan WIFI network connection, a mobile or cellular network connection (e.g., Third Generation (3G), Fourth Generation (4G), Long-Term Evolution (LTE), 5th Generation (5G), etc.), and/or other wireless network connection (e.g., License Assisted Access (LAA), Citizens Broadband Radio Service (CBRS), MULTEFIRE, etc.). The communication stack 520 can also facilitate local exchange of information, such as through a wired connection (e.g., a user's mobile computing device docked in an in-car docking station or connected via Universal Serial Bus (USB), etc.) or a local wireless connection (e.g., Wireless Local Area Network (WLAN), Bluetooth®, infrared, etc.).

The HD geospatial database 522 can store HD maps and related data of the streets upon which the AV 502 travels. In some embodiments, the HD maps and related data can comprise multiple layers, such as an areas layer, a lanes and boundaries layer, an intersections layer, a traffic controls layer, and so forth. The areas layer can include geospatial information indicating geographic areas that are drivable (e.g., roads, parking areas, shoulders, etc.) or not drivable (e.g., medians, sidewalks, buildings, etc.), drivable areas that constitute links or connections (e.g., drivable areas that form the same road) versus intersections (e.g., drivable areas where two or more roads intersect), and so on. The lanes and boundaries layer can include geospatial information of road lanes (e.g., lane centerline, lane boundaries, type of lane boundaries, etc.) and related attributes (e.g., direction of travel, speed limit, lane type, etc.). The lanes and boundaries layer can also include 3D attributes related to lanes (e.g., slope, elevation, curvature, etc.). The intersections layer can include geospatial information of intersections (e.g., crosswalks, stop lines, turning lane centerlines and/or boundaries, etc.) and related attributes (e.g., permissive, protected/permissive, or protected only left turn lanes; legal or illegal U-turn lanes; permissive or protected only right turn lanes; etc.). The traffic controls lane can include geospatial information of traffic signal lights, traffic signs, and other road objects and related attributes.

The AV operational database 524 can store raw AV data generated by the sensor systems 504-508 and other components of the AV 502 and/or data received by the AV 502 from remote systems (e.g., the data center 550, the client computing device 570, etc.). In some embodiments, the raw AV data can include HD LIDAR point cloud data, image data, RADAR data, GPS data, and other sensor data that the data center 550 can use for creating or updating AV geospatial data as discussed further below with respect to FIG. 2 and elsewhere in the present disclosure.

Data center 550 can be a private cloud (e.g., an enterprise network, a co-location provider network, etc.), a public cloud (e.g., an Infrastructure as a Service (IaaS) network, a Platform as a Service (PaaS) network, a Software as a Service (SaaS) network, or other Cloud Service Provider (CSP) network), a hybrid cloud, a multi-cloud, and so forth. The data center 550 can include one or more computing devices remote to the local computing device 510 for managing a fleet of AVs and AV-related services. For example, in addition to managing the AV 502, the data center 550 may also support a ridesharing service, a delivery service, a remote/roadside assistance service, street services (e.g., street mapping, street patrol, street cleaning, street metering, parking reservation, etc.), and the like.

Data center 550 can send and receive various signals to and from the AV 502 and client device 570. These signals can include sensor data captured by the sensor systems 504-508, roadside assistance requests, software updates, ridesharing pick-up and drop-off instructions, and so forth. In this example, the data center 550 includes a data management platform 552, an Artificial Intelligence/Machine Learning (AI/ML) platform 554, a simulation platform 556, a remote assistance platform 558, a ridesharing platform 560, and map management system platform 562, among other systems.

Data management platform 552 can be a “big data” system capable of receiving and transmitting data at high velocities (e.g., near real-time or real-time), processing a large variety of data, and storing large volumes of data (e.g., terabytes, petabytes, or more of data). The varieties of data can include data having different structure (e.g., structured, semi-structured, unstructured, etc.), data of different types (e.g., sensor data, mechanical system data, ridesharing service, map data, audio, video, etc.), data associated with different types of data stores (e.g., relational databases, key-value stores, document databases, graph databases, column-family databases, data analytic stores, search engine databases, time series databases, object stores, file systems, etc.), data originating from different sources (e.g., AVs, enterprise systems, social networks, etc.), data having different rates of change (e.g., batch, streaming, etc.), or data having other heterogeneous characteristics. The various platforms and systems of the data center 550 can access data stored by the data management platform 552 to provide their respective services.

The AI/ML platform 554 can provide the infrastructure for training and evaluating machine learning algorithms for operating the AV 502, the simulation platform 556, the remote assistance platform 558, the ridesharing platform 560, the map management system platform 562, and other platforms and systems. Using the AI/ML platform 554, data scientists can prepare data sets from the data management platform 552; select, design, and train machine learning models; evaluate, refine, and deploy the models; maintain, monitor, and retrain the models; and so on.

The simulation platform 556 can enable testing and validation of the algorithms, machine learning models, neural networks, and other development efforts for the AV 502, the remote assistance platform 558, the ridesharing platform 560, the map management system platform 562, and other platforms and systems. The simulation platform 556 can replicate a variety of driving environments and/or reproduce real-world scenarios from data captured by the AV 502, including rendering geospatial information and road infrastructure (e.g., streets, lanes, crosswalks, traffic lights, stop signs, etc.) obtained from the map management system platform 562; modeling the behavior of other vehicles, bicycles, pedestrians, and other dynamic elements; simulating inclement weather conditions, different traffic scenarios; and so on.

Remote assistance platform 558 can generate and transmit instructions regarding the operation of the AV 502. For example, in response to an output of the AI/ML platform 554 or other system of the data center 550, the remote assistance platform 558 can prepare instructions for one or more stacks or other components of the AV 502.

Ridesharing platform 560 can interact with a customer of a ridesharing service via a ridesharing application 572 executing on the client computing device 570. The client computing device 570 can be any type of computing system, including a server, desktop computer, laptop, tablet, smartphone, smart wearable device (e.g., smart watch, smart eyeglasses or other Head-Mounted Display (HMD), smart ear pods or other smart in-ear, on-ear, or over-ear device, etc.), gaming system, or other general purpose computing device for accessing the ridesharing application 572. The client computing device 570 can be a customer's mobile computing device or a computing device integrated with the AV 502 (e.g., the local computing device 510). The ridesharing platform 560 can receive requests to be picked up or dropped off from the ridesharing application 572 and dispatch the AV 502 for the trip.

Map management system platform 562 can provide a set of tools for the manipulation and management of geographic and spatial (geospatial) and related attribute data. The data management platform 552 can receive LIDAR point cloud data, image data (e.g., still image, video, etc.), RADAR data, GPS data, and other sensor data (e.g., raw data) from one or more AVs 502, UAVs, satellites, third-party mapping services, and other sources of geospatially referenced data. The raw data can be processed, and map management system platform 562 can render base representations (e.g., tiles (2D), bounding volumes (3D), etc.) of the AV geospatial data to enable users to view, query, label, edit, and otherwise interact with the data. Map management system platform 562 can manage workflows and tasks for operating on the AV geospatial data. Map management system platform 562 can control access to the AV geospatial data, including granting or limiting access to the AV geospatial data based on user-based, role-based, group-based, task-based, and other attribute-based access control mechanisms. Map management system platform 562 can provide version control for the AV geospatial data, such as to track specific changes that (human or machine) map editors have made to the data and to revert changes when necessary. Map management system platform 562 can administer release management of the AV geospatial data, including distributing suitable iterations of the data to different users, computing devices, AVs, and other consumers of HD maps. Map management system platform 562 can provide analytics regarding the AV geospatial data and related data, such as to generate insights relating to the throughput and quality of mapping tasks.

In some aspects, the map viewing services of map management system platform 562 can be modularized and deployed as part of one or more of the platforms and systems of the data center 550. For example, the AI/ML platform 554 may incorporate the map viewing services for visualizing the effectiveness of various object detection or object classification models, the simulation platform 556 may incorporate the map viewing services for recreating and visualizing certain driving scenarios, the remote assistance platform 558 may incorporate the map viewing services for replaying traffic incidents to facilitate and coordinate aid, the ridesharing platform 560 may incorporate the map viewing services into the client application 572 to enable passengers to view the AV 502 in transit en route to a pick-up or drop-off location, and so on.

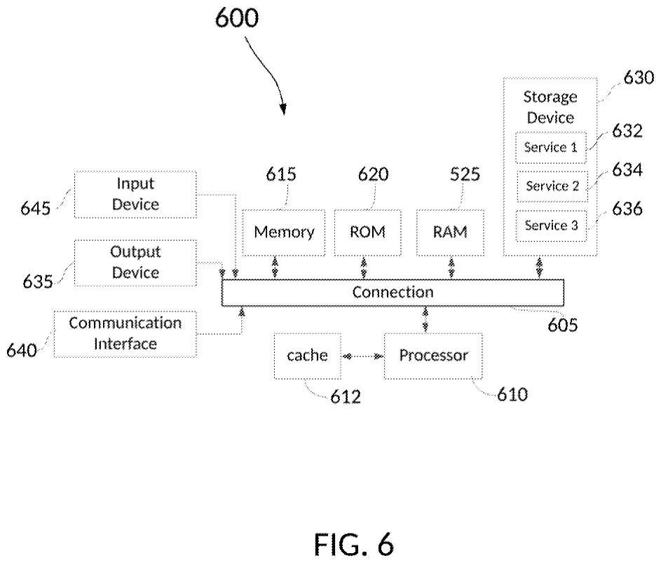

FIG. 6 illustrates an example processor-based system with which some aspects of the subject technology can be implemented. For example, processor-based system 600 can be any computing device making up internal computing system 610, remote computing system 650, a passenger device executing the rideshare app 670, internal computing device 630, or any component thereof in which the components of the system are in communication with each other using connection 605. Connection 605 can be a physical connection via a bus, or a direct connection into processor 610, such as in a chipset architecture. Connection 605 can also be a virtual connection, networked connection, or logical connection.

In some implementations, computing system 600 is a distributed system in which the functions described in this disclosure can be distributed within a datacenter, multiple data centers, a peer network, etc. In some aspects, one or more of the described system components represents many such components each performing some or all of the function for which the component is described. In some embodiments, the components can be physical or virtual devices.

System 600 includes at least one processing unit (CPU or processor) 610 and connection 605 that couples various system components including system memory 615, such as read-only memory (ROM) 620 and random access memory (RAM) 625 to processor 610. Computing system 600 can include a cache of high-speed memory 612 connected directly with, in close proximity to, or integrated as part of processor 610.

Processor 610 can include any general purpose processor and a hardware service or software service, such as services 632, 634, and 636 stored in storage device 630, configured to control processor 610 as well as a special-purpose processor where software instructions are incorporated into the actual processor design. Processor 610 may essentially be a completely self-contained computing system, containing multiple cores or processors, a bus, memory controller, cache, etc. A multi-core processor may be symmetric or asymmetric.

To enable user interaction, computing system 600 includes an input device 645, which can represent any number of input mechanisms, such as a microphone for speech, a touch-sensitive screen for gesture or graphical input, keyboard, mouse, motion input, speech, etc. Computing system 600 can also include output device 635, which can be one or more of a number of output mechanisms known to those of skill in the art. In some instances, multimodal systems can enable a user to provide multiple types of input/output to communicate with computing system 600. Computing system 600 can include communications interface 640, which can generally govern and manage the user input and system output.

Communication interface 640 may perform or facilitate receipt and/or transmission wired or wireless communications via wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof.

Communication interface 640 may also include one or more Global Navigation Satellite System (GNSS) receivers or transceivers that are used to determine a location of the computing system 600 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 630 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (L1/L2/L3/L4/L5/L#), resistive random-access memory (RRAM/ReRAM), phase change memory (PCM), spin transfer torque RAM (STT-RAM), another memory chip or cartridge, and/or a combination thereof.

Storage device 630 can include software services, servers, services, etc., that when the code that defines such software is executed by the processor 610, it causes the system to perform a function. In some embodiments, a hardware service that performs a particular function can include the software component stored in a computer-readable medium in connection with the necessary hardware components, such as processor 610, connection 605, output device 635, etc., to carry out the function.

As understood by those of skill in the art, machine-learning based classification techniques can vary depending on the desired implementation. For example, machine-learning classification schemes can utilize one or more of the following, alone or in combination: hidden Markov models; recurrent neural networks; convolutional neural networks (CNNs); deep learning; Bayesian symbolic methods; general adversarial networks (GANs); support vector machines; image registration methods; applicable rule-based system. Where regression algorithms are used, they may include including but are not limited to: a Stochastic Gradient Descent Regressor, and/or a Passive Aggressive Regressor, etc.

Machine learning classification models can also be based on clustering algorithms (e.g., a Mini-batch K-means clustering algorithm), a recommendation algorithm (e.g., a Miniwise Hashing algorithm, or Euclidean Locality-Sensitive Hashing (LSH) algorithm), and/or an anomaly detection algorithm, such as a Local outlier factor. Additionally, machine-learning models can employ a dimensionality reduction approach, such as, one or more of: a Mini-batch Dictionary Learning algorithm, an Incremental Principal Component Analysis (PCA) algorithm, a Latent Dirichlet Allocation algorithm, and/or a Mini-batch K-means algorithm, etc.

Embodiments within the scope of the present disclosure may also include tangible and/or non-transitory computer-readable storage media or devices for carrying or having computer-executable instructions or data structures stored thereon. Such tangible computer-readable storage devices can be any available device that can be accessed by a general purpose or special purpose computer, including the functional design of any special purpose processor as described above. By way of example, and not limitation, such tangible computer-readable devices can include RAM, ROM, EEPROM, CD-ROM or other optical disk storage, magnetic disk storage or other magnetic storage devices, or any other device which can be used to carry or store desired program code in the form of computer-executable instructions, data structures, or processor chip design. When information or instructions are provided via a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable storage devices.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform tasks or implement abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Other embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

The various embodiments described above are provided by way of illustration only and should not be construed to limit the scope of the disclosure. For example, the principles herein apply equally to optimization as well as general improvements. Various modifications and changes may be made to the principles described herein without following the example embodiments and applications illustrated and described herein, and without departing from the spirit and scope of the disclosure. Claim language reciting “at least one of” a set indicates that one member of the set or multiple members of the set satisfy the claim.

What is claimed is:

1. A computer-implemented method comprising:
receiving a disaster notification, at a fleet management system, wherein the disaster notification comprises a disaster type and a disaster location;
identifying, by the fleet management system, an affected area based on the disaster type and the disaster location;
deploying, by the fleet management system, one or more autonomous robots to a map location corresponding with the disaster location; and
receiving, by the fleet management system, updated map information for the map location from the one or more autonomous robots.

2. The computer-implemented method of claim 1, further comprising:
generating a Common Operating Picture (COP) comprising one or more blacklisted vehicle routes.

3. The computer-implemented method of claim 1, further comprising:
updating a Common Operating Picture (COP) based on disaster information received from one or more third-party systems.

4. The computer-implemented method of claim 1, wherein the updated map information comprises one or more of: an air quality measurement, a temperature measurement, or flood map data.

5. The computer-implemented method of claim 1, wherein the updated map information comprises population density data.

6. The computer-implemented method of claim 1, wherein the one or more autonomous robots comprises an autonomous vehicle (AV).

7. The computer-implemented method of claim 1, wherein the one or more autonomous robots comprises an autonomous drone.

8. A system comprising:
one or more processors; and
a computer-readable medium comprising instructions stored therein, which when executed by the processors, cause the processors to perform operations comprising:
receiving a disaster notification, at a fleet management system, wherein the disaster notification comprises a disaster type and a disaster location;
identifying, by the fleet management system, an affected area based on the disaster type and the disaster location;
deploying, by the fleet management system, one or more autonomous robots to a map location corresponding with the disaster location; and
receiving, by the fleet management system, updated map information for the map location from the one or more autonomous robots.

9. The system of claim 8, wherein the processors are further configured to perform operations comprising:
generating a Common Operating Picture (COP) comprising one or more blacklisted vehicle routes.

10. The system of claim 8, wherein the processors are further configured to perform operations comprising:
updating a Common Operating Picture (COP) based on disaster information received from one or more third-party systems.

11. The system of claim 8, wherein the updated map information comprises one or more of: an air quality measurement, a temperature measurement, or flood map data.

12. The system of claim 8, wherein the updated map information comprises population density data.

13. The system of claim 8, wherein the one or more autonomous robots comprises an autonomous vehicle (AV).

14. The system of claim 8, wherein the one or more autonomous robots comprises an autonomous drone.

15. A non-transitory computer-readable storage medium, comprising instructions stored therein, which when executed by one or more processors, cause the processors to perform operations comprising:
receiving a disaster notification, at a fleet management system, wherein the disaster notification comprises a disaster type and a disaster location;
identifying, by the fleet management system, an affected area based on the disaster type and the disaster location;
deploying, by the fleet management system, one or more autonomous robots to a map location corresponding with the disaster location; and
receiving, by the fleet management system, updated map information for the map location from the one or more autonomous robots.

16. The non-transitory computer-readable storage medium of claim 15, wherein the instructions are further configured to cause the processors to perform operations comprising:
generating a Common Operating Picture (COP) comprising one or more blacklisted vehicle routes.

17. The non-transitory computer-readable storage medium of claim 15, wherein the instructions are further configured to cause the processors to perform operations comprising:
updating a Common Operating Picture (COP) based on disaster information received from one or more third-party systems.

18. The non-transitory computer-readable storage medium of claim 15, wherein the updated map information comprises one or more of: an air quality measurement, a temperature measurement, or flood map data.

19. The non-transitory computer-readable storage medium of claim 15, wherein the updated map information comprises population density data.

20. The non-transitory computer-readable storage medium of claim 15, wherein the one or more autonomous robots comprises an autonomous vehicle (AV).
